(19) United States
(12) Patent Application Publication
(10) Pub. No.: US 2008/0032561 A1
(43) Pub. Date: Feb. 7, 2008

(54) Slim memory card with retractable protection shield

(75) Inventors: Siew S. Hiew, San Jose, CA (US); Jim Ni, San Jose, CA (US); Ming-Shiang Shen, Hsin Chuang (TW)

Correspondence Address: BACON & THOMAS, PLLC, 625 SLATERS LANE, FOURTH FLOOR, ALEXANDRIA, VA, 22314, US

(73) Assignee: Super Talent Electronics Inc., San Jose, CA (US)

(21) Appl. No.: 11/907,024

(22) Filed: Oct. 9, 2007

Related U.S. Application Data
(63) Continuation-in-part of application No. 11/642,667, filed on Dec. 21, 2006.
Application No. 11/642,667 is a division of application No. 09/478,720, filed on Jan. 6, 2000, now Pat. No. 7,257,714.

(51) Int. Cl. H01R 33/00

(52) U.S. Cl. 439/660; 29/829

(57) ABSTRACT

A slim USB memory card is provided with retractable protection shield. A printed circuit board has a surface formed thereon a plurality of metal contacts. A main frame piece has two frame edges parallel with and opposite to each other for housing the printed circuit board. Each frame edge has an inner edge defined therein a track. A protection shield piece has two lateral sides. Each lateral side has a sliding bar, wherein the sliding bars sit on the tracks at the inner edges of the main frame piece, so as to glide back and forth on the tracks to perform cover and retract movement to protect the metal contacts.

### RELATED APPLICATIONS

This application is a continuation-in-part (CIP) of the co-pending application for:

(1) “Electronic Data Storage Medium with Fingerprint Verification Capability”, U.S. Ser. No. 11/642,667 filed Jan. 18, 2007 which is a division of application Ser. No. 09/478,720, filed Jan. 06, 2000;

(2) “Reduced-Length, Low profile USB Device And Card-Like Carrier”, U.S. Ser. No. 11/257,575-1252, filed Oct. 24, 2005; and

(3) “Low-Profile USB Device”, U.S. Ser. No. 11/112,501, filed Apr. 21, 2005.

This application is also related to the following patent:

“Manufacturing Methods for Ultra-slim USB Flash-Memory Card with Supporting Dividers or Underside Ribs”, U.S. Pat. No. 7,094,074 B2, filed Oct. 28, 2004.

### BACKGROUND OF THE INVENTION

1. Field of the Invention

The present invention relates to a USB device and, more particularly, to a slim USB memory card with retractable protection shield.

2. Description of Related Art

Flash-memory technologies such as those using electrically-erasable programmable read-only memory (EEPROM) have produced chips storing 1 G-Bytes or more. Small flash-memory cards have been designed that have a connector that can plug into a specialized reader, such as for compact-flash, secure-digital, memory stick, or other standardized formats.

More recently, flash memory cards are being sold that contain a USB connector. Such USB-flash memory cards do not require a specialized reader but can be plugged into a USB connector on a personal computer (PC) or other hosting device. These USB-flash memory cards can be used in place of floppy disks. A USB-flash card can have a capacity of more than ten floppy disks in an area not much larger than a large postage stamp.

FIG. 1 shows a prior-art flash-memory card with a USB connector, in which metal contacts 11 are located on the lower surface of male USB connector 12. Plastic case 13 has an opening on the lower surface of male USB connector 12 to expose the metal contacts 11 so they can make electrical connection with PC or other hosting device.

As consumer gadgets are getting slimmer and smaller in shape and size, there is a greater need of designing smaller and thinner foot print USB products to meet the requirements of the market trends. There are many manufacturers started to design and to produce slim USB products with the thickness of 2.0 mm. Even though the slim and small objectives have been met, the prior art lack the protection of the contactor pins from contamination or scratch (or even damage in a more severe scenario). This prompts a need in designing a retractable protective shield over the contact pins when not in used.

### SUMMARY OF THE INVENTION

The object of the present invention is to provide a slim USB memory card with retractable protection shield, which can protect the metal contacts from scratches and contamination, thereby ensuring the performance and reliability of the USB memory card.

According to one aspect, the present invention which achieves the object relates to a slim USB memory card with retractable protection shield, which includes: a printed circuit board having a surface formed thereon a plurality of metal contacts, a main frame piece having two frame edges parallel with and opposite to each other for housing the printed circuit board, each frame edge having an inner edge defined therein a track; and a protection shield piece having two lateral sides, each lateral side having a sliding bar, wherein the sliding bars sit on the tracks at the inner edges of the main frame piece, so as to glide back and forth on the tracks to perform cover and retract movement to protect the metal contacts.

According to another aspect, the present invention which achieves the object relates to a method for manufacturing a slim memory card, which includes the steps of: (A) providing a printed circuit board manufactured using SMT process, the printed circuit board having an upper surface formed thereon a plurality of metal contacts and a lower surface formed thereon a plurality of electronic components; (B) providing a main frame piece having two frame edges parallel with and opposite to each other and defined. therebetween a cavity window opening, each frame edge having an inner edge defined therein a track; (C) placing a protection shield piece onto the main frame piece, the protection shield piece having two lateral sides, each having a sliding bar which sits on a corresponding track at the inner edge of the main frame piece; (D) inserting the print circuit board through the cavity window into the main frame piece for being received between the two frame edges; and (E) attaching a bottom cover piece to a bottom of the main frame piece.

According to a further aspect, the present invention which achieves the object relates to a method for manufacturing a slim memory card, which includes the steps of: (A) providing a printed circuit board manufactured using chip-on-board process, the printed circuit board having an upper surface formed thereon a plurality of metal contacts; (B) providing a main frame piece having two frame edges parallel with and opposite to each other and defined therebetween a rectangular cavity, each frame edge having an inner edge defined therein a track; (C) taping a piece of thin double sided thermal adhesive tape 43 onto the cavity of the main frame piece; (D) taping a bottom side of the printed circuit board on a top side of the adhesive tape; and (E) placing a protection shield piece onto the main frame piece, the protection shield piece having two lateral sides, each having a sliding bar which sits on a corresponding track at the inner edge of the main frame piece.

Other objects, advantages, and novel features of the invention will become more apparent from the following detailed description when taken in conjunction with the accompanying drawings.

### BRIEF DESCRIPTION OF THE DRAWINGS

FIG. 1 shows a prior-art flash-memory card with a USB connector;

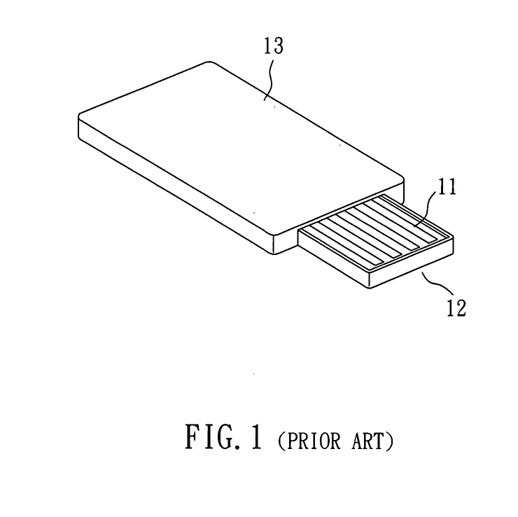

FIG. 2 shows a slim USB memory card with retractable protection shield in accordance with the present invention;

FIG. 3 shows the explode view of the slim USB memory card with retractable protection shield in accordance with the present invention;

FIG. 4 illustrates the relative position of electronic components on a printed circuit board displayed with the bottom side up;

FIG. 5 shows the explode view of the slim USB memory card with retractable protection shield manufactured using UV-cure epoxy process; and

FIG. 6 shows the explode view of the slim USB memory card with retractable protection shield manufactured using COB process.

### DETAILED DESCRIPTION OF THE PREFERRED EMBODIMENT

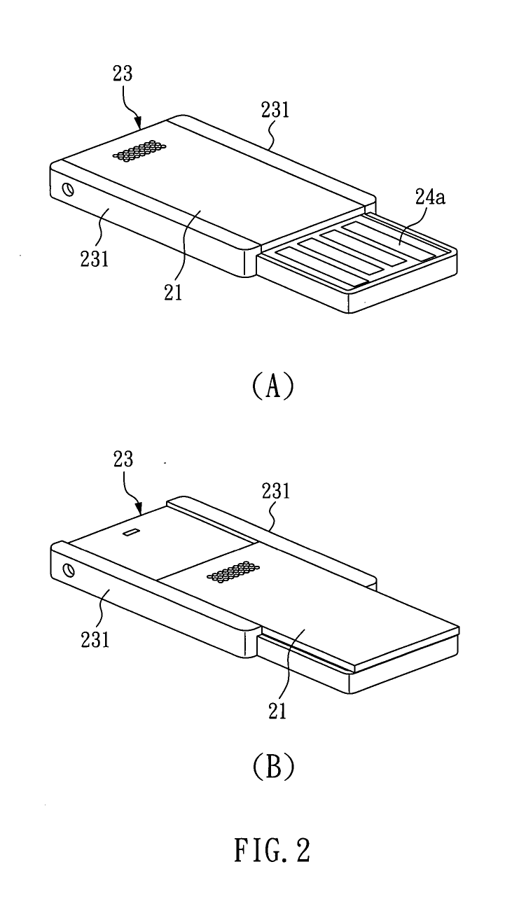

With reference to FIG. 2, there is shown a slim USB memory card with retractable protection shield in accordance with the present invention. As shown, the slim USB memory card with retractable protection shield includes a main frame piece 23 having two frame edges 231 parallel with and opposite to each other, and a protection shield piece 21 slidably disposed between the two frame edges 231 of the main frame piece 23 to glide back and forth for performing cover and retract movement to protect four metal contacts 24a of a printed circuit board disposed in the main frame piece 23. FIG. 2(A) shows the slim USB memory card with the protection shield piece 21 withdrawn for exposing the metal contacts 24a that is ready to insert into a host device (not shown), while FIG. 2(B) shows the slim USB memory card with the protection shield piece 21 being pushed forwards by thumb to cover the metal contacts 24a region.

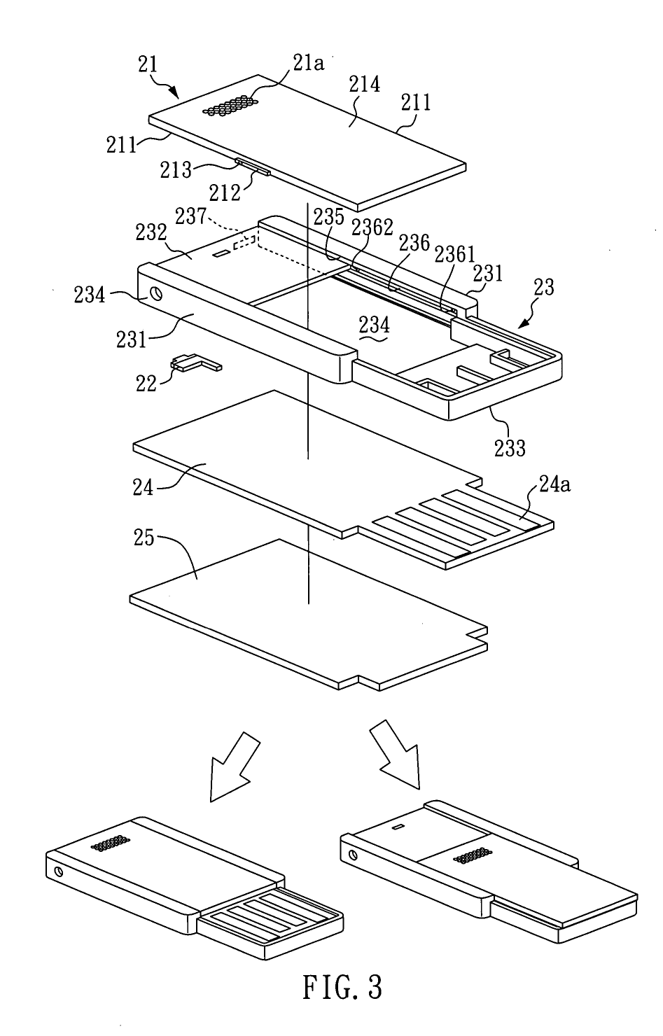

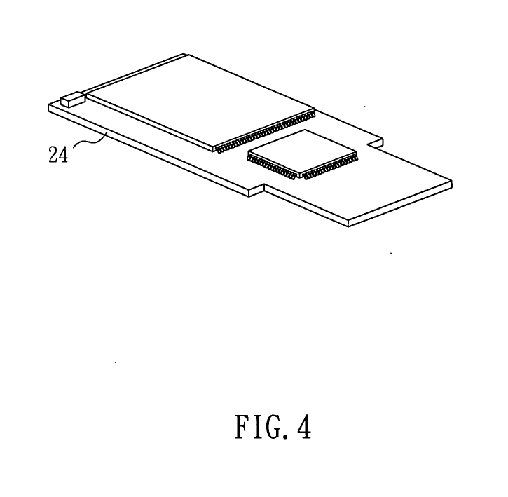

To realize the structure of the slim USB memory card with retractable protection shield and its manufacture process, FIG. 3 shows the explode view of the slim USB memory card with retractable protection shield. The manufacture process begins with providing the printed circuit board 24 as shown in FIG. 3. The printed circuit board 24 is manufactured using Surface Mount Technology (SMT) process. The view shows the top surface of the printed circuit board 24 on which four metal contacts 24a are formed. All the electronic components are at the lower surface of the printed circuit board 24. To illustrate the relative position of electronic components on the printed circuit board 24, the printed circuit board 24 is displayed with the bottom side up as shown in FIG. 4.

Referring back to FIG. 3 again, a main frame piece 23 made of plastic is pre-molded to have two frame edges 231, a frame plate 232 connected with the frame edges 231, and a frame head 233 extended from the frame edges 231. The two frame edges 231 are parallel with each other and opposite to each other thereby defining a cavity window opening 234 between the two frame edges 231. Each frame edge 231 has an inner edge 235 defined therein a track 236. Each of the tracks 236 has a front part defined therein a first recess 2361. Each of the tracks 236 has a back part defined therein a second recess 2362. From the cavity window opening 234 at the bottom side, it allows the printed circuit board 24 and a metal or plastic protection shield piece 21 to be inserted and placed in the main frame piece 23.

The main frame piece 23 also has a through hole 234 defined in one of the frame edges 231 for the purpose of looping through a piece of string or chain (not shown) to act as a soft carrying handle or key chain holder or small ornaments holder.

Then, a colored transparent light emitting diode (LED) cover 22 is inserted into a hole 237 at the back edge of the main frame piece 23 from the inside out.

Next, the protection shield piece 21 is inserted into the main frame piece 23. The protection shield piece 21 has two lateral sides 211. Each lateral side 211 has a sliding bar 212. When being assembled to the main frame piece 23, the sliding bars 212 sit on the tracks 236 at the inner edges 235 of the main frame piece 23, so as to glide back and forth on the tracks 236 to perform cover and retract movement to protect the metal contacts 24a.

Each of the sliding bars 212 has a back end formed thereon a raised tip 213 that serves as stopper at a retracted position where the raised tips 213 sink into the first recesses 2361 at the track 236 of the main frame piece 23, and the raised tips 213 sink into the second recesses 2362 as the protection shield piece 21 is fully covered the metal contacts 24a.

The protection shield piece 21 has an upper surface 214 formed thereon a plurality of bump pads 21a to provide better friction between thumb (or finger) for sliding the protection shield piece 21 back and forth.

Subsequently, the printed circuit board 24 is inserted into the main frame piece 23. When being placed in the main frame piece 23, the metal contacts 24a of the printed circuit board 24 are located on the frame head 233.

After the printed circuit board 24 is snugly fitted into the main frame piece 23, a bottom cover piece 25 is attached to the bottom of the main frame piece 23 by ultrasonic press method where high frequency vibrating force and mechanical press force are applied to the 1.0 mm width from the outer edges of the perimeters of the bottom cover piece 25. The plastic materials of the bottom cover piece 25 and the bottom sides of the main frame piece 23 are melted at high vibrating frequency plus compressing forces that fused the two plastic together. Once the bottom cover piece 25 and the main frame piece 23 are fused, the final product of slim USB memory card is formed.

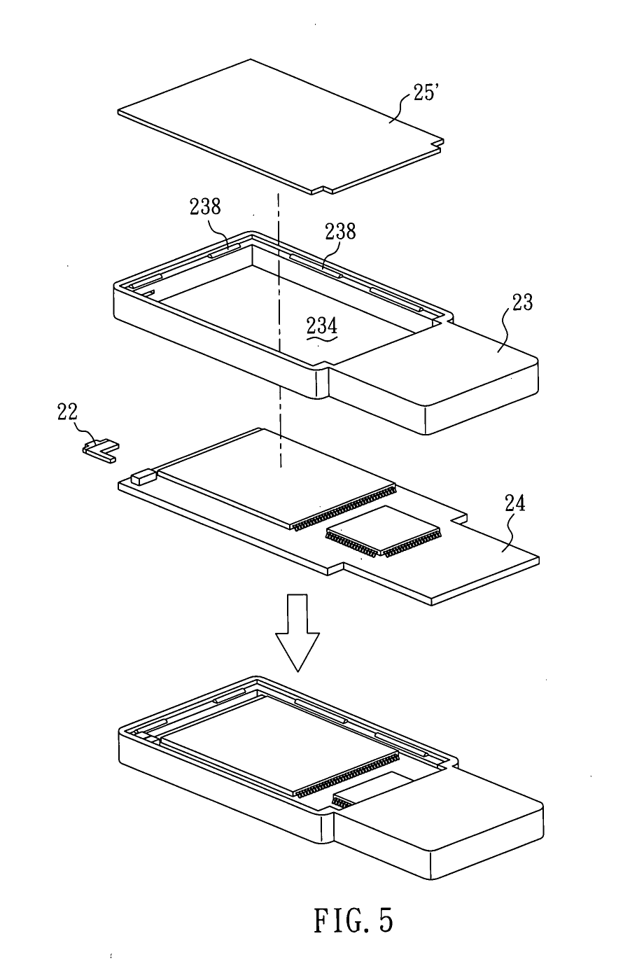

In addition to using ultrasonic press process for adhering the bottom cover piece 25 to the main frame piece 23, an alternative UV-cure epoxy process is also applicable as described in FIG. 5. FIG. 5 shows the explode view of the slim USB memory card with retractable protection shield manufactured by UV-cure epoxy process. As shown, after the printed circuit board 24 is snugly fitted into the main frame piece 23, the bottom edges 238 of the main frame piece 23 are dispensed with ultra-violet light (UV) sensitive epoxy glue. After dispensing UV sensitive epoxy, a transparent or translucent bottom cover piece 25′ is placed on the edges of the cavity window opening 234. The outer edges of the transparent or translucent bottom cover piece 25′ is adhered to the main frame piece 23 by UV-sensitive epoxy.

The sealed package of slim USB memory card with retractable protection shield is then performed with a curing process by exposing the sealed slim USB memory card with the transparent or translucent bottom cover piece 25′ facing up under ultra violet light. The UV light penetrates the transparent and translucent bottom cover piece 25′ and activates the cross linking process in the UV sensitive epoxy adhesive material. Typically, it takes less than five minutes to cure and harden the epoxy.

After the bottom cover sealing process, the slim USB memory card with retractable protection shield is then proceed to marking process where company logo, memory size and speed information are marked on the top side of the slim USB memory card. The bottom side of the slim USB memory card may have a transparent or translucent window that allows users to view the internal electronic components at a glance. This feature added attractive esthetic value to the final product.

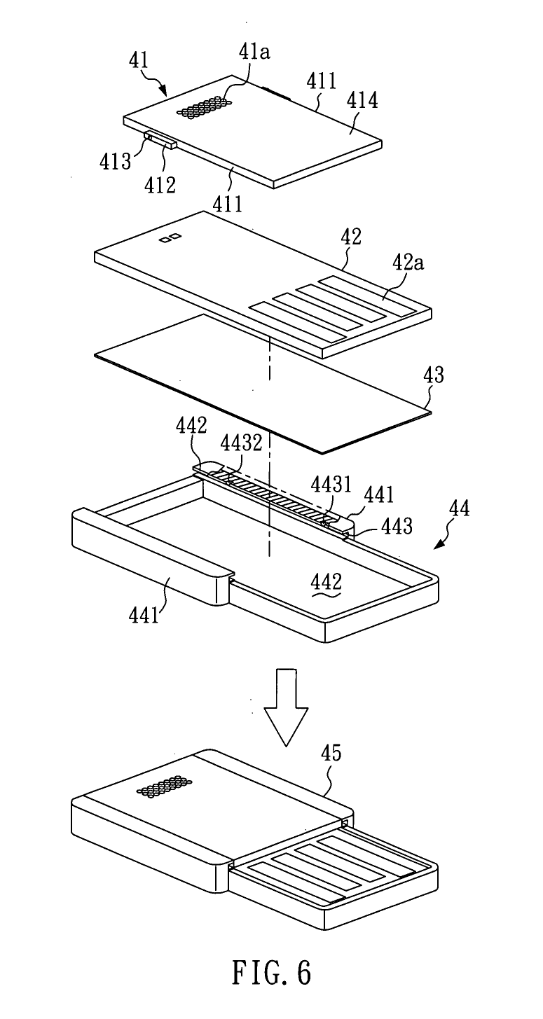

In addition to using the printed circuit board manufactured by SMT process, an alternative slim USB memory card package using COB process is also available, as illustrated in the explode view of FIG. 6. Assembly details are described as follow.

First, there is provided a printed circuit board 42 manufactured using chip-on-board (COB) process. The view shows the top surface of the printed circuit board 42 on which a plurality of metal contacts 42a are formed.

A main frame piece 44 made of plastic is provided to have two frame edges 441. The two frame edges 44 are parallel with each other and opposite to each other thereby defining a rectangular cavity 442 between the two frame edges 441 for fitting the COB printed circuit board 42 snugly. Each frame edge 441 has an inner edge 442 defined therein a track 443. Each of the tracks 443 has a front part defined therein a first recess 4431. Each of the tracks 443 has a back part defined therein a second recess 4432.

Then, a piece of thin double sided thermal adhesive tape 43 is taped onto the cavity 442 of the main frame piece 44. The bottom side of the COB printed circuit board 42 is taped on the top side of adhesive tape 43.

Next, a metal or plastic protection shield piece 41 is inserted into the main frame piece 44. The protection shield piece 41 has two lateral sides 411. Each lateral side 411 has a sliding bar 412. When being assembled to the main frame piece 44, the sliding bars 412 sit on the tracks 443 at the inner edges 442 of the main frame piece 44, so as to glide back and forth on the tracks 443 to perform cover and retract movement to protect the metal contacts 42a.

Each of the sliding bars 412 has a back end formed thereon a raised tip 413 that serves as stopper at a retracted position where the raised tips 413 sink into the first recesses 4431 at the track 443 of the main frame piece 44, and the raised tips 413 sink into the second recesses 4432 as the protection shield piece 41 is fully covered the metal contacts 42a.

The protection shield piece 41 has an upper surface 414 formed thereon a plurality of bump pads 41a to provide better friction between thumb (or finger) for sliding the protection shield piece 41 back and forth. The completed slim USB memory card with retractable protection shield shows the metal or plastic protection shield piece 41 in the retracted position.

In view of the foregoing, it is known that the present invention is able to protect the metal contacts from scratches and contamination, wherein clean contact points maintenance is the insurance of consistence performance and reliability over time, thereby ensuring the performance and reliability of the USB memory card.

Although the present invention has been explained in relation to its preferred embodiment, it is to be understood that many other possible modifications and variations can be made without departing from the spirit and scope of the invention as hereinafter claimed.

What is claimed is:

1. A slim USB memory card with retractable protection shield comprising:
a printed circuit board having a surface formed thereon a plurality of metal contacts,
a main frame piece having two frame edges parallel with and opposite to each other for housing the printed circuit board, each frame edge having an inner edge defined therein a track; and
a protection shield piece having two lateral sides, each lateral side having a sliding bar, wherein the sliding bars sit on the tracks at the inner edges of the main frame piece, so as to glide back and forth on the tracks to perform cover and retract movement to protect the metal contacts.

2. The slim USB memory card as claimed in claim 1, wherein each of the tracks has a front part defined therein a first recess and each of the sliding bars has a back end formed thereon a raised tip that serves as stopper at a retracted position where the raised tips sink into the first recesses at the track of the main frame piece.

3. The slim USB memory card as claimed in claim 2, wherein each of the tracks has a back part defined therein a second recess, and the raised tip sink into the second recesses as the protection shield piece is fully covered the metal contacts.

4. The slim USB memory card as claimed in claim 3, wherein the main frame piece has a frame plate connected with the two frame edges and a frame head extended from the frame edges, and the metal contacts of the printed circuit board are located on the frame head.

5. The slim USB memory card as claimed in claim 4, further comprising a bottom cover piece disposed below the main frame piece for sealing the main frame piece.

6. The slim USB memory card as claimed in claim 3, further comprising an LED cover 22 inserted into the main frame piece.

7. The slim USB memory card as claimed in claim 3, wherein the printed circuit board is provided with a plurality of electronic components.

8. The slim USB memory card as claimed in claim 3, wherein the protection shield piece is made of metal or plastic.

9. The slim USB memory card as claimed in claim 6, wherein the protection shield piece has an upper surface formed thereon a plurality of bump pads.

10. The slim USB memory card as claimed in claim 6, wherein the main frame piece has a through hole defined in one of the frame edges.

11. A method for manufacturing a slim memory card comprising the steps of:
(A) providing a printed circuit board manufactured using SMT process, the printed circuit board having an upper surface formed thereon a plurality of metal contacts and a lower surface formed thereon a plurality of electronic components;
(B) providing a main frame piece having two frame edges parallel with and opposite to each other and defined therebetween a cavity window opening, each frame edge having an inner edge defined therein a track;
(C) placing a protection shield piece onto the main frame piece, the protection shield piece having two lateral sides, each having a sliding bar which sits on a corresponding track at the inner edge of the main frame piece;
(D) inserting the print circuit board through the cavity window into the main frame piece for being received between the two frame edges; and
(E) attaching a bottom cover piece to a bottom of the main frame piece.

12. The method as claimed in claim 11, further comprising, between step (B) and (C), the step of:
(F) inserting an LED cover into a window hole at a back edge of the main frame piece.

13. The method as claimed in claim 11, wherein step (E) is executed by ultrasonic press process to attach the bottom cover piece to the main body frame.

14. The method as claimed in claim 11, wherein step (E) is executed by UV-cure epoxy process to attach the bottom cover piece to the main body frame.

15. The method as claimed in claim 14, wherein the bottom cover piece is transparent or translucent.

16. A method for manufacturing a slim memory card comprising the steps of:
(A) providing a printed circuit board manufactured using chip-on-board process, the printed circuit board having an upper surface formed thereon a plurality of metal contacts;
(B) providing a main frame piece having two frame edges parallel with and opposite to each other and defined therebetween a rectangular cavity, each frame edge having an inner edge defined therein a track;
(C) taping a piece of thin double sided thermal adhesive tape 43 onto the cavity of the main frame piece;
(D) taping a bottom side of the printed circuit board on a top side of the adhesive tape; and
(E) placing a protection shield piece onto the main frame piece, the protection shield piece having two lateral sides, each having a sliding bar which sits on a corresponding track at the inner edge of the main frame piece.
